(19) United States
(12) Patent Application Publication
(10) Pub. No.: US 2019/0271888 A1
(43) Pub. Date: Sep. 5, 2019

(54) LIQUID CRYSTAL DISPLAY DEVICE

(71) Applicant: SHARP KABUSHIKI KAISHA, Sakai City (JP)

(72) Inventors: MASANOBU MIZUSAKI, Sakai City (JP); KIYOSHI MINOURA, Sakai City (JP)

(21) Appl. No.: 16/289,966

(22) Filed: Mar. 1, 2019

(30) Foreign Application Priority Data
Mar. 2, 2018 (JP) 2018-037891

(51) Int. Cl. G02F 1/1343; G02F 1/1337; G02F 1/137; C09K 19/56; C09K 19/30

(52) U.S. Cl. CPC G02F 1/134363; G02F 1/133711; G02F 1/137; C09K 19/56; G02F 2001/133397; C09K 19/3003; G02F 2001/133738; G02F 2001/13706; G02F 2001/13712; C09K 19/3066

(57) ABSTRACT

The present invention provides a horizontal alignment mode liquid crystal display device capable of suppressing a decrease in VHR and an increase in residual DC when the liquid crystal display device includes an alignment film containing an azobenzene group-containing polymer. The liquid crystal display device includes: a first substrate including a pixel electrode and a counter electrode; a second substrate disposed opposite to the first substrate; a liquid crystal layer containing a liquid crystal material between the first substrate and the second substrate; and an alignment film containing an azobenzene group-containing polymer having an azobenzene group between the first substrate and the liquid crystal layer, wherein the alignment film is disposed out of contact with the pixel electrodes.

### CROSS-REFERENCE TO RELATED APPLICATIONS

The present application claims priority under 35 U.S.C. § 119 to Japanese Patent Application No. 2018-037891 filed on Mar. 2, 2018, the contents of which are incorporated herein by reference in their entirety.

### BACKGROUND OF THE INVENTION

### Field of the Invention

The present invention relates to liquid crystal display devices. Specifically, the present invention relates to a liquid crystal display device suitably used as a horizontal alignment mode liquid crystal display device.

### Description of Related Art

Liquid crystal display devices use a liquid crystal composition for display. According to a typical display mode, a voltage is applied to a liquid crystal composition sealed between a pair of substrates to change the alignment of liquid molecules (liquid crystal compounds) in the liquid crystal composition according to the applied voltage, whereby the amount of transmitted light is controlled. Such liquid crystal display devices have advantageous features such as thin profile, lightweight, and low power consumption, and are thus used in a wide range of fields.

A horizontal alignment mode, which controls the alignment of liquid crystal molecules by rotating the liquid crystal molecules mainly in a plane parallel to the substrate surface, is drawing attention as a display mode of liquid crystal display devices because it can easily provide wide viewing angle characteristics. For example, many recent liquid crystal display devices such as smartphones and tablet personal computers use a horizontal alignment mode such as an in-plane switching (IPS) mode or a fringe field switching (FFS) mode.

For example, WO 2017/141824 discloses an FFS mode liquid crystal display device including: a first substrate including pixel electrodes; a second substrate disposed opposite to the first substrate; a liquid crystal layer disposed between the first substrate and the second substrate; an aromatic polyimide alignment film disposed on at least one of the first substrate or the second substrate; and a radical generation source that can supply radicals to the liquid crystal layer when irradiated with light, wherein the liquid crystal layer contains a liquid crystal compound containing an alkenyl group, the aromatic polyimide alignment film contains at least one polymer selected from a polyimide and a polyamic acid and is disposed out of contact with the pixel electrodes, and the at least one polymer contains an aromatic tetracarboxylic acid dianhydride monomer unit.

JP 2014-197238 A discloses a liquid crystal display panel including: pixel electrodes and a common electrode formed on one of two substrates between which a liquid crystal layer is disposed; multiple scanning lines and multiple signal lines disposed in a display region; a common conductive line formed along a periphery of the display region; and a conductive layer disposed at a position overlapping the signal lines in a plan view, the conductive layer being electrically connected to the common electrode and having higher conductivity than that of the common electrode, wherein the conductive layer has a linear shape extending to the common conductive line along the signal lines, extends to the periphery of the display region, and is electrically connected to the common conductive line in the periphery of the display region.

### BRIEF SUMMARY OF THE INVENTION

In order to achieve a high response speed and low voltage driving, the nematic phase-isotropic phase transition temperature (Tni) of a liquid crystal material (a positive liquid crystal material having positive anisotropy of dielectric constant or a negative liquid crystal material having negative anisotropy of dielectric constant) may be decreased to 72° C. or lower for example, or to 60° C. in some cases, and additionally, a relatively highly polar compound may be introduced into the liquid crystal materials.

Here, in the case of an FFS mode liquid crystal display device (a horizontal alignment mode liquid crystal display device), generally, an increase in the amount of a polar component (s) in the liquid crystal material results in a higher refractive index of the liquid crystal material, which may increase light scattering in the liquid crystal layer and decrease the contrast ratio.

Thus, the present inventors focused on alignment treatment on an alignment film to suppress a decrease in the contrast ratio. Examples of the alignment treatment method include a rubbing method in which a surface of the alignment film is rubbed with a roller or the like, and a photoalignment method in which a surface of the alignment film is irradiated with light. The photoalignment method can perform more uniform alignment treatment and achieve more uniform alignment of liquid crystal molecules than the rubbing method. Thus, the photoalignment method can achieve good liquid crystal alignment over the entire substrate surface and increase the contrast ratio of the liquid crystal display device.

The alignment treatment by the photoalignment method uses a photoalignment film such as an alignment film containing a polymer having a photoisomerization group such as an azobenzene group (hereinafter also referred to as a “photoisomerization alignment film”), an alignment film containing a polymer having a photodecomposition group such as a cyclobutane ring (hereinafter also referred to as a “photodecomposition alignment film”), or an alignment film containing a polymer having a photodimerization group such as a cinnamate group (hereinafter also referred to as a “photodimerization alignment film”).

Use of the photodimerization alignment film requires a large amount of light irradiation to induce a dimerization reaction, which renders handling during the production process difficult. In addition, the photodimerization alignment film fails to sufficiently improve properties such as contrast ratio. Use of the photodecomposition alignment film may result in a low-molecular-weight decomposition product, which may dissolve into the liquid crystal layer, causing spots and/or image sticking.

In contrast, use of the photoisomerization alignment film results in no decomposition product and achieves a high contrast ratio. Thus, the present inventors focused on an alignment film containing an azobenzene group-containing polymer having an azobenzene group.

Generally, the azobenzene group switches between cis and trans forms upon exposure to light (ultraviolet light). Thus, the alignment of liquid crystal molecules can be controlled by defining the isomerization direction by polarized ultraviolet light for alignment treatment on an alignment film. However, when carriers are injected from pixel electrodes, the azobenzene group in the alignment film may undergo a reaction as shown in the following formula 1, generating a radical anion or a radical cation.

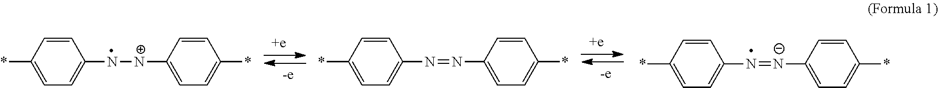

The following describes, with reference to FIG. 4, a reason for generation of a radical anion or a radical cation from the azobenzene group by injection of carriers from a pixel electrode.

FIG. 4 is a schematic view of a waveform of a voltage applied from a pixel electrode and a counter electrode. Usually, a pixel electrode applies a rectangular wave voltage (pulse voltage) corresponding to a frequency and resolution as shown in FIG. 4, and the applied voltage is variable. In the case of a refresh rate of 60 Hz with the resolution of full high vision, the voltage application time of one pulse is as short as approximately 15 μs. In addition, generally, when the pixel electrode is in contact with a dielectric, the pixel electrode makes charge interactions with a free electron in a molecule and/or a n-conjugated substance constituting the dielectric for a moment immediately upon changes in the value of the applied voltage.

Thus, when the alignment film containing an azobenzene group-containing polymer is in contact with a pixel electrode, a current flows into the azobenzene group from the pixel electrode, or conversely, a current flows into the pixel electrode from the azobenzene group (see the formula 1), immediately upon changes in the value of the voltage. When such electronic transfer (a redox reaction) occurs continuously during driving of the liquid crystal display device, an ion (a radical anion or a radical cation) is ultimately generated from the azobenzene group.

In contrast, when a dielectric in contact with a pixel electrode is formed from a material (such as an inorganic material) that is less likely to make charge interactions, changes in the applied voltage do not cause charge interactions (electronic transfer) between the pixel electrode and the inorganic material, thus not resulting in ionization.

Usually, only a fixed voltage is inserted by a counter (common) electrode. When only a fixed voltage is inserted as described above, an equilibrium state is quickly established between the electrode and the dielectric due to the absence of time-dependent changes in the applied voltage, and charge interactions as shown in the formula 1 do not occur between the electrode and the dielectric, thus not resulting in redox reaction. Thus, ionization does not occur or hardly occurs even when the counter electrode is in contact with the alignment film containing an azobenzene group-containing polymer.

A contact between the alignment film containing an azobenzene group-containing polymer and a pixel electrode causes a radical anion or a radical cation generated from the azobenzene group to transfer to a liquid crystal compound (particularly, a polar or highly polar liquid crystal compound), thus generating a radical or a radical ion (a radical cation or a radical anion) in the liquid crystal layer. For example, when a highly polar liquid crystal compound is used, a positive liquid crystal material undergoes a reaction as shown in the following formula 2, whereas a negative liquid crystal material undergoes a reaction as shown in the following formula 3.

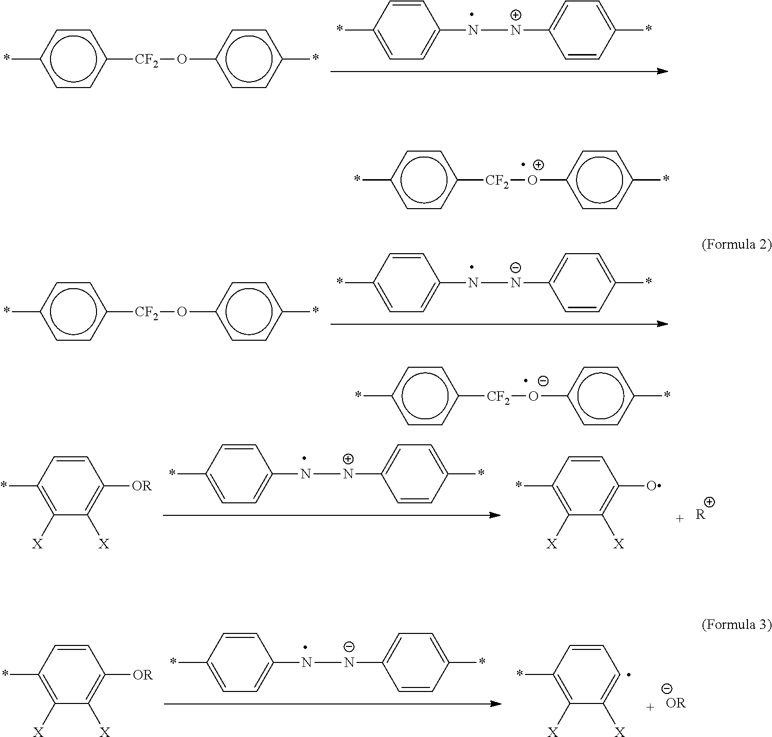

Generation of a radical or a radical ion in the liquid crystal layer results in a lower voltage holding ratio (VHR) and a higher residual DC, causing defects such as image sticking.

WO 2017/141824 is completely silent about the alignment film containing an azobenzene group-containing polymer. The invention disclosed in JP 2014-197238 A aims to provide an FFS mode liquid crystal display panel in which flicker and crosstalk are reduced by lowering the electric resistance value of a common electrode, and nowhere discloses a technique to suppress a decrease in VHR and an increase in residual DC of a liquid crystal display device including an alignment film containing an azobenzene group-containing polymer.

The present invention has been made in view of such a current state of the art and aims to provide a horizontal alignment mode liquid crystal display device capable of suppressing a decrease in VHR and an increase in residual DC when the liquid crystal display device includes an alignment film containing an azobenzene group-containing polymer.

As a result of various studies on horizontal alignment mode liquid crystal display devices capable of suppressing a decrease in VHR and an increase in residual DC when the liquid crystal display devices include an alignment film containing an azobenzene group-containing polymer, the present inventors focused on the arrangement of pixel electrodes and an alignment film disposed on a substrate. Then, they found that when an alignment film containing an azobenzene group-containing polymer is disposed out of contact with pixel electrodes disposed on a substrate, it is possible to prevent generation of a radical anion or a radical cation from the azobenzene group which occurs in association with injection of carrier from the pixel electrodes. Thus, the present inventors have arrived at the solution to the above problem, completing the present invention.

Specifically, one aspect of the present invention may be a liquid crystal display device including: a first substrate including a pixel electrode and a counter electrode; a second substrate disposed opposite to the first substrate; a liquid crystal layer containing a liquid crystal material between the first substrate and the second substrate; and an alignment film containing an azobenzene group-containing polymer having an azobenzene group between the first substrate and the liquid crystal layer, wherein the alignment film is disposed out of contact with the pixel electrodes.

The liquid crystal material may have a nematic phase-isotropic phase transition point of 72° C. or lower.

The liquid crystal material may have positive anisotropy of dielectric constant.

The liquid crystal material may contain at least one of: at least one liquid crystal compound containing a group represented by the following chemical formula (A1), or at least one liquid crystal compound containing a group represented by the following chemical formula (A2):

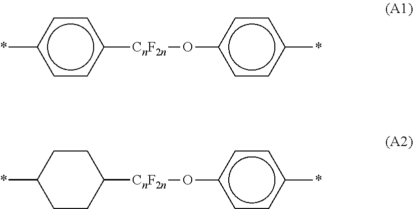

wherein n represents an integer of 1 to 3; * represents a binding site; and at least one hydrogen atom may be replaced.

In the chemical formulae (A1) and (A2), n may be 1.

The liquid crystal material may have negative anisotropy of dielectric constant.

The liquid crystal material may contain at least one liquid crystal compound containing a group represented by the following chemical formula (B1).

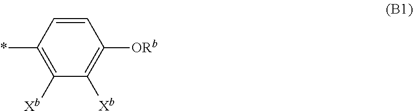

wherein R^{b} represents a C1-C20 saturated alkyl group; each X^{b} independently represents a halogen atom; * represents a binding site; and at least one hydrogen atom may be replaced.

In the chemical formula (B1), at least one X^{b} may be a fluorine atom.

The azobenzene group-containing polymer may have an azobenzene group in the main chain.

The azobenzene group-containing polymer may have at least one of a polyamic acid structure or a polyimide structure.

The polyamic acid structure may be at least one structure represented by the following chemical formula (PA), and the polyimide structure may be at least one structure represented by the following chemical formula (PI):

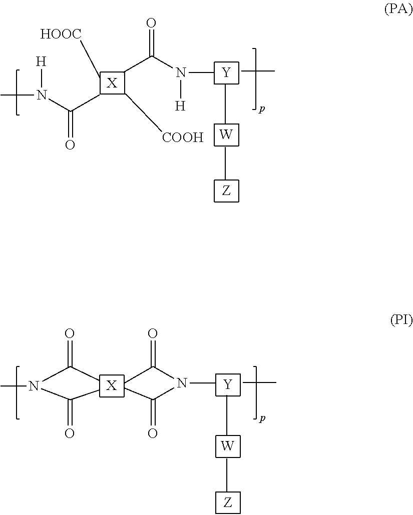

wherein when X is a group represented by the following chemical formula (X-1), each Y is the same or different and is a group represented by any of the following chemical formulae (Y-3) to (Y-11); when Y is a group represented by the following chemical formula (Y-1) or (Y-2), each X is the same or different and is a group represented by any of the following chemical formulae (X-2) to (X-8); each W is the same or different and is a direct bond or a group represented by any of the following chemical formulae (W-1) to (W-3); each Z is the same or different and is a group represented by any of the following chemical formulae (Z-1) to (Z-8); and p represents an integer of 1 or greater,

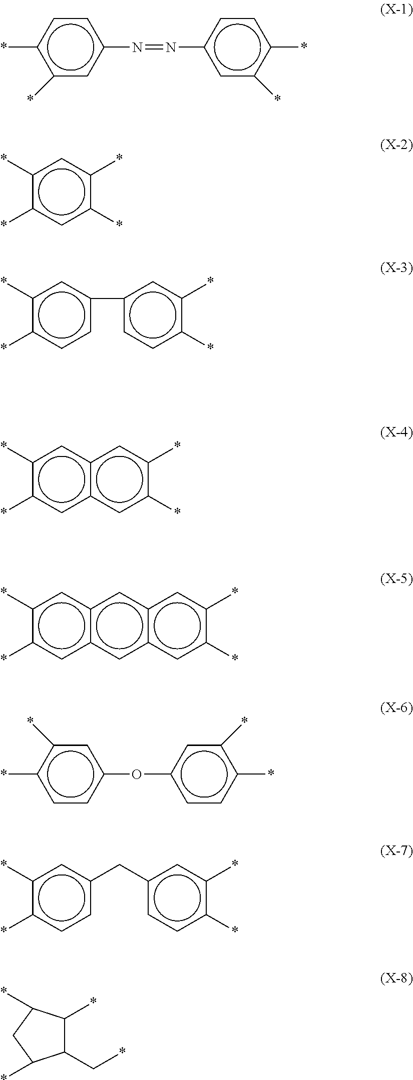

wherein * represents a binding site, and at least one hydrogen atom may be replaced,

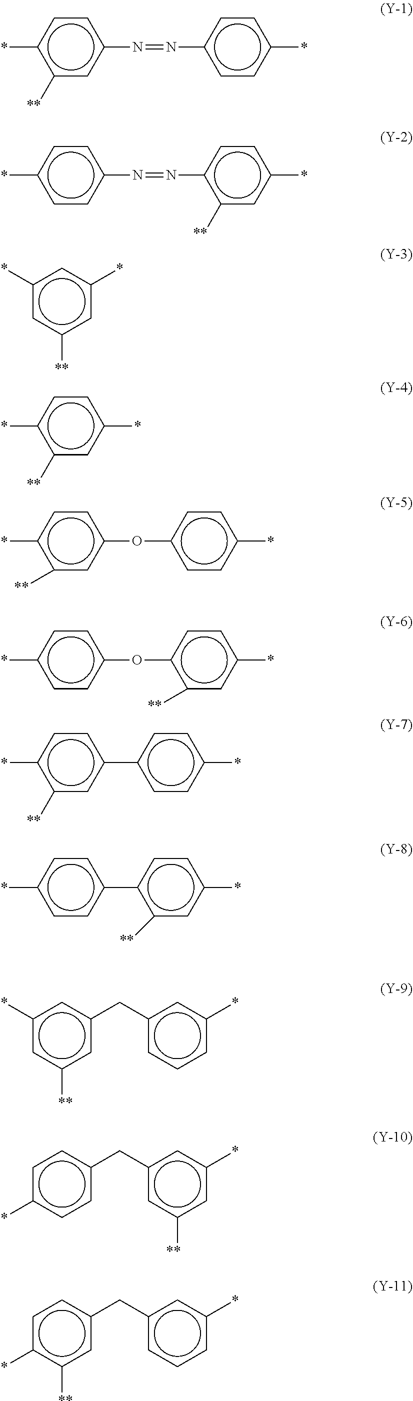

wherein * represents a binding site to a nitrogen atom; ** represents a binding site to W; and at least one hydrogen atom may be replaced,

*—COO—* (W-1)

*—CONH—* (W-2)

*—O—* (W-3)

wherein * represents a binding site,

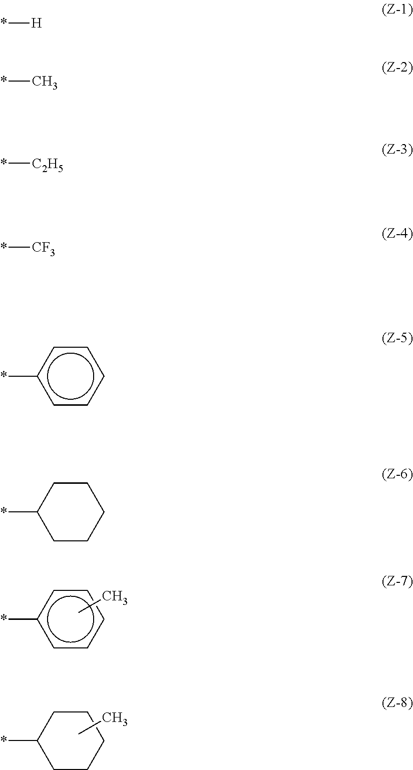

wherein * represents a binding site, and at least one hydrogen atom may be replaced.

The first substrate may further contain an insulating film, and the insulating film may cover the pixel electrodes and may not contain the azobenzene group-containing polymer having an azobenzene group.

The liquid crystal display device may be a fringe field switching mode liquid crystal display device, and the first substrate may include the counter electrode, the insulating film, and the pixel electrodes in this order from the liquid crystal layer side.

The liquid crystal display device may be a fringe field switching mode liquid crystal display device, the insulating film may be a first insulating film, and the first substrate may further include a second insulating film and may include the first insulating film, the pixel electrodes, the second insulating film, and the counter electrode in the this order from the liquid crystal layer side.

The liquid crystal display device may be an in-plane switching mode liquid crystal display device, and the insulating film may be disposed closer to the liquid crystal layer than the pixel electrodes and the counter electrode.

The present invention can provide a horizontal alignment mode liquid crystal display device capable of suppressing a decrease in VHR and an increase in residual DC when the liquid crystal display device includes an alignment film containing an azobenzene group-containing polymer.

### BRIEF DESCRIPTION OF THE DRAWINGS

FIG. 1 is a schematic cross-sectional view of a liquid crystal display device of Embodiment 1.

FIG. 2 is a schematic cross-sectional view of a liquid crystal display device of Embodiment 2.

FIG. 3 is a schematic cross-sectional view of a liquid crystal display device of Embodiment 3.

FIG. 4 is a schematic view of a waveform of a voltage applied from a pixel electrode and a counter electrode.

FIG. 5 is a schematic cross-sectional view of a liquid crystal display device of Comparative Example 1-1.

### DETAILED DESCRIPTION OF THE INVENTION

Embodiments of the present invention are described below. The embodiments, however, are not intended to limit the scope of the present invention, and modifications can be appropriately made to the design within the scope of the present invention.

In the following description, the same reference symbols are used throughout the drawings to refer to identical elements or elements having similar functions, and repetitive descriptions are omitted.

Features described in the embodiments may appropriately be combined or modified within the spirit of the present invention.

### Embodiment 1

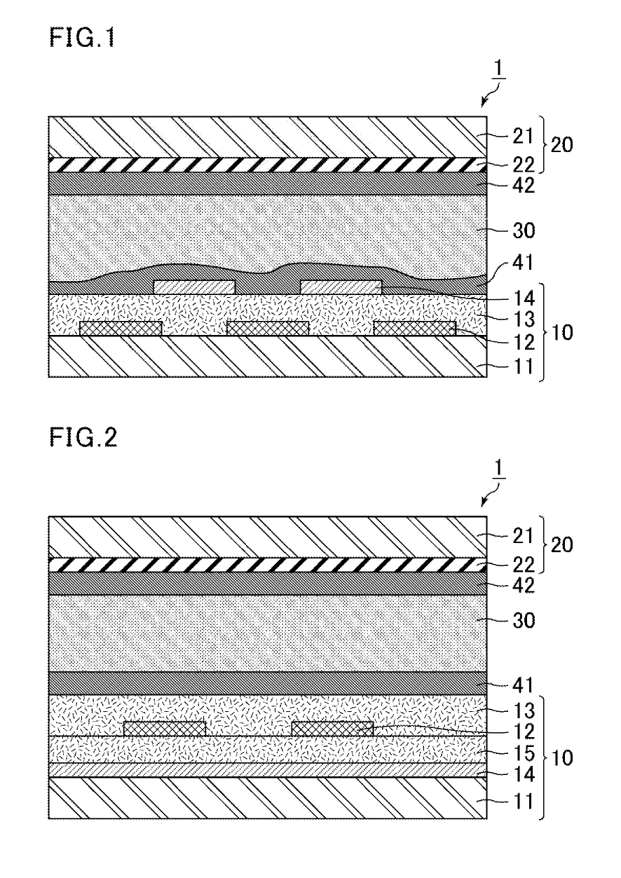

The present embodiment describes an example of a fringe field switching (FFS) mode liquid crystal display device. FIG. 1 is a schematic cross-sectional view of a liquid crystal display device of Embodiment 1. As shown in FIG. 1, a liquid crystal display device 1 of the present embodiment includes: a first substrate 10; a second substrate 20 disposed opposite to the first substrate 10; a liquid crystal layer 30 disposed between the first substrate 10 and the second substrate 20; a first alignment film 41 disposed between the first substrate 10 and the liquid crystal layer 30; and a second alignment film 42 disposed between the second substrate 20 and the liquid crystal layer 30, wherein the first alignment film 41 and the second alignment film 42 each contain an azobenzene group-containing polymer having an azobenzene group.

The liquid crystal display device of the embodiment further includes: a first polarizing plate (not shown) disposed on the first substrate 10, on the side opposite to the liquid crystal layer 30; a second polarizing plate (not shown) disposed on the second substrate 20, on the side opposite to the liquid crystal layer 30; and a backlight (not shown) disposed on the first polarizing plate, on the side opposite to the liquid crystal layer 30.

As shown in FIG. 1, the first substrate 10 includes an insulating substrate 11, pixel electrodes 12, an insulating film (first insulating film) 13, and a counter electrode (common electrode) 14 including slits (openings) in this order toward the liquid crystal layer 30. The first substrate 10 is also referred to as an FFS electrode substrate.

As shown in FIG. 1, the second substrate 20 includes an insulating substrate 21 and layers such as color filters 22 and a black matrix (not shown) in this order toward the liquid crystal layer 30. The second substrate 20 is also referred to as a counter substrate.

Here, when the alignment film containing an azobenzene group-containing polymer is used in contact with the pixel electrodes, a redox reaction occurs on the interface between the pixel electrodes and the alignment film due to transfer of charge to the azobenzene group, thus forming a radical ion, as shown in the formula 1. Further, since the radical ion is transferred to a liquid crystal compound (particularly, a polar or highly polar liquid crystal compound) in the liquid crystal layer, the VHR will decrease and the residual DC will increase.

In the present embodiment, the first alignment film 41 containing an azobenzene group-containing polymer disposed on the first substrate 10 is disposed out of contact with the pixel electrodes 12 of the first substrate 10. This embodiment can prevent injection of carriers from the pixel electrodes 12 into the first alignment film 41, and can prevent conversion of the azobenzene group into a radical ion by the redox reaction as shown in the formula 1. As a result, it is possible to prevent a reaction that produces a radical or a radical ion in the liquid crystal layer 30 due to the radical ion generated from the azobenzene group (e.g., the reaction shown in the formula 2 or 3), thus suppressing a decrease in VHR and an increase in residual DC in the liquid crystal display device 1. The second alignment film 42 disposed opposite to the first substrate 10 across the liquid crystal layer 30 is also disposed out of contact with the pixel electrodes 12 of the first substrate 10, so that a decrease in VHR and an increase in residual DC due to the azobenzene group in the second alignment film 42 can be similarly suppressed. Thus, the liquid crystal display device 1 of the present embodiment can achieve a level of problem-free reliability at which no image sticking occurs even after long-term use.

More specifically, as shown in FIG. 1, in the first substrate 10, the pixel electrodes 12 that apply a voltage is disposed on the lower side of the insulating film 13 made of an inorganic material, and the first alignment film 41 is disposed out of contact with the pixel electrodes 12. In addition, the counter electrode 14 is disposed on the insulating film 13 so that the counter electrode 14 is in contact with the first alignment film 41. With this embodiment, a direct contact is avoided between the pixel electrodes 12 and the azobenzene group in the first alignment film 41, thus preventing conversion of the azobenzene group into a radical ion by the redox reaction as shown in the formula 1. Thus, neither conversion of the azobenzene group into a radical ion by the redox reaction nor transfer of the radical ion to a liquid crystal compound (particularly, a highly polar liquid crystal compound) will occur, thus enabling suppression of a decrease in VHR and an increase in residual DC in the liquid crystal display device 1. As described above, injection of carriers does not occur at the interface between the counter electrode 14 and the first alignment film 41. Details of the present embodiment are described below.

The first substrate 10 includes multiple source lines (not shown), multiple gate lines (not shown) intersecting the source lines, and multiple thin-film transistors (TFTs) (not shown). The pixel electrodes 12 are disposed in respective regions each defined by two adjacent source lines and two adjacent gate lines.

Each TFT is connected to a corresponding source line and a corresponding gate line among the multiple source lines and the multiple gate lines, and is a three-way switch including a thin film semiconductor, a source electrode constituted by a part of the corresponding source line, a gate electrode constituted by a part of the corresponding gate line, and a drain electrode connected to a corresponding pixel electrode 12 among the multiple pixel electrodes 12.

Each pixel electrode 12 is connected to a corresponding source line via the thin film semiconductor, and application of a source signal to each pixel electrode 12 is controlled by turning on/off of a corresponding gate line to control the potential, whereby the pixel potential can be freely controlled. Thus, a fringe electric field is generated between the pixel electrodes 12 and the counter electrode 14 including slits and disposed above the pixel electrodes 12 across the first insulating film 13, whereby liquid crystal molecules (liquid crystal compounds) in the liquid crystal layer 30 are rotated. In this manner, the level of voltage to be applied between the pixel electrodes 12 and the counter electrode 14 is controlled to vary the retardation of the liquid crystal layer 30, whereby transmission or non-transmission of light is controlled.

In an active matrix display mode which includes switching elements such as TFTs, usually, when a TFT disposed in each pixel is turned on, a signal voltage is applied to the pixel electrode through the TFT. Electric charge charged in a pixel by voltage application is held in the pixel while the TFT is turned off. The ratio of charged electric charge held in one frame period (e.g., 16.7 ms) is referred to as a voltage holding ratio (VHR). In other words, a low VHR ratio indicates that the voltage applied to the liquid crystal layer 30 tends to attenuate over time. In an active matrix display mode, a high VHR is required.

The insulating film 13 functions as an interlayer insulating film that insulates between the pixel electrodes 12 and the counter electrode 14. The insulating film 13 contains no azobenzene group-containing polymer having an azobenzene group. With this embodiment, a redox reaction can be prevented between the pixel electrodes 12 and the insulating film 13, further suppressing a decrease in VHR and an increase in residual DC (rDC).

In the present embodiment, the insulating film 13 is an inorganic insulating film, but may also be an organic insulating film other than the azobenzene group-containing polymer or a stack of the organic insulating film and an inorganic insulating film. Examples of the inorganic insulating film include inorganic films (relative dielectric constant ε=5 to 7) such as silicon nitride (SiNx) films and silicon oxide (SiO₂) films, and multilayer films thereof. Examples of the organic insulating film include organic films having a low relative dielectric constant (relative dielectric constant ε=2 to 5) such as photosensitive acrylic resin films.

In the FFS mode as in the present embodiment, as shown in FIG. 1, an FFS electrode structure is preferably formed by the pixel electrodes 12, the insulating film 13 covering the pixel electrodes 12, and the counter electrode 14 on the insulating film 13. With this structure, an oblique electric field (fringe electric field) is formed in the liquid crystal layer 30 during voltage application. In this case, the counter electrode 14 is a slit electrode. For example, the slit electrode may be one including linear openings as slits each entirely surrounded by electrodes, or one having a comb shape including multiple comb teeth and linear cuts as slits between the comb teeth. Meanwhile, each pixel electrode 12 may be a planar electrode formed to occupy its respective pixel region or a slit electrode each including slits as shown in FIG. 1. In the latter case, each pixel electrode 12 includes slits in such a manner that electrode portions of the pixel electrodes 12 entirely overlap the slits of the counter electrode 14.

The second substrate 20 has a structure including the insulating substrate 21, a grid-shaped black matrix (not shown), and the color filters 22 formed inward of the cells of the grid (in the pixels). The color filters 22 may be disposed on the first substrate 10 instead of the second substrate 20.

The liquid crystal layer 30 contains a liquid crystal material. A voltage is applied to the liquid crystal layer 30 to change the alignment of liquid crystal compounds in the liquid crystal material according to the applied voltage, whereby the amount of transmitted light is controlled.

The liquid crystal material preferably has a nematic phase-isotropic phase transition point (Tni) of 72° C. or lower. A liquid crystal material having a Tni of 72° C. or lower has a low viscosity. While a liquid crystal material having low viscosity is effective in increasing the response speed of the liquid crystal display device, it also allows impurity ions in the liquid crystal material to easily move. When impurity ions can easily move in the liquid crystal material (the liquid crystal layer in the liquid crystal display device), ions that cannot move in a highly viscous environment also start moving. This results in a more significant decrease in VHR. Further, when the density of movable ions increases in the liquid crystal layer, the movable ions reach the interface between the liquid crystal layer and the alignment film, which increases the density of ions adsorbed onto a surface of the alignment film. This results in an increase in rDC. Thus, when the alignment film containing an azobenzene group-containing polymer is used, a decrease in VHR and an increase in rDC due to generation of impurity ions (radical ions) in the liquid crystal layer are rendered particularly remarkable by the use of a low-viscosity liquid crystal material having a Tni of 72° C. or lower. In other words, when the Tni is 72° C. or lower, image sticking and/or spots easily occur due to a decrease in VHR and an increase in rDC, easily resulting in poor reliability.

However, in the liquid crystal display device 1 of the present embodiment, the first alignment film 41 and the second alignment film 42 each containing an azobenzene group-containing polymer are both disposed out of contact with the pixel electrodes 12, preventing injection of carriers from the pixel electrodes 12 into the first alignment film 41 and the second alignment film 42, and enabling effective suppression of a decrease in VHR and an increase in rDC in the liquid crystal display device 1 even when a liquid crystal material having a Tni of 72° C. or lower is used.

The liquid crystal material preferably has a Tni of 60° C. or higher in view of actual usage. When the Tni is lower than 60° C., the liquid crystal material may undergo transition to the isotropic phase during use of the liquid crystal display device 1, rendering a displayed image unrecognizable. In contrast, when the Tni is higher than 72° C., the viscosity of the liquid crystal material is so high that the liquid crystal display device 1 may have very poor response characteristics. The Tni of the liquid crystal material can be measured as follows: the liquid crystal material is placed in a thin capillary; the transparency (transmittance) is monitored while the temperature of the capillary is increased; and the temperature at which the transmittance starts increasing can be regarded as the Tni.

The Tni of the liquid crystal material can be adjusted to 72° C. or lower by introducing, for example, a liquid crystal compound containing two cyclic units and having a relatively low molecular weight into the liquid crystal material. Examples of the cyclic units include benzene rings and cyclohexane rings. The two cyclic units in one molecule of the liquid crystal compound 1 may be the same as or different from each other.

Preferred examples of the liquid crystal compound containing two cyclic units and having a relatively low molecular weight include at least one liquid crystal compound represented by the following chemical formula (D1) and at least one liquid crystal compound represented by the following chemical formula (D2). Any of these can be used alone or in combination of two or more thereof. At least one liquid crystal compound represented by the following chemical formula (D1) is a polar liquid crystal compound (a liquid crystal compound having negative anisotropy of dielectric constant), and at least one liquid crystal compound represented by the following chemical formula (D2) is a non-polar liquid crystal compound:

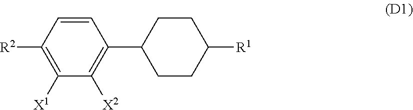

wherein X¹ and X² each independently represent a hydrogen atom or a fluorine atom; and R¹ and R² each independently represents a C1-C5 hydrocarbon group:

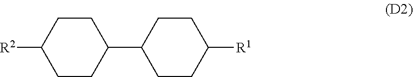

wherein R¹ and R² each independently represent a C1-C5 hydrocarbon group.

Examples of the C1-C5 hydrocarbon group represented by R¹ and R² in the chemical formula (D1) and by R¹ and R² in the chemical formula (D2) include saturated hydrocarbon groups and unsaturated hydrocarbon groups. The saturated hydrocarbon groups and the unsaturated hydrocarbon groups may be each a linear structure, a branched structure, or a ring structure. Examples of the ring structure include a cyclohexane structure.

The liquid crystal material used in the present embodiment may have positive or negative anisotropy of dielectric constant (Δε) defined by the following formula. The liquid crystal material having positive anisotropy of dielectric constant is also referred to as a positive liquid crystal material, and the liquid crystal material having negative anisotropy of dielectric constant is also referred to as a negative liquid crystal material. The direction of the major axes of the liquid crystal molecules is the direction of a slow axis. The liquid crystal molecules are homogeneously aligned in a state where no voltage is applied (non-voltage applied state), and the direction of the major axes of the liquid crystal molecules in the non-voltage applied state is also referred to as the direction of an initial alignment of the liquid crystal molecules.

Δε=(Dielectric constant in direction of major axes)−(Dielectric constant in direction of minor axes)

The anisotropy of dielectric constant (Δε) of the liquid crystal material can be determined by producing a horizontally aligned liquid crystal cell and calculating the dielectric constant in the direction of the major axes and the dielectric constant in the direction of the minor axes from capacitance values before and after a high voltage application. The birefringence index (Δn) of the liquid crystal material can be measured using an Abbe refractometer.

When the liquid crystal material is a positive liquid crystal material, the anisotropy of dielectric constant of the liquid crystal material is preferably 2 to 15, more preferably 2.5 to 6. When the liquid crystal material is a negative liquid crystal material, the anisotropy of dielectric constant of the liquid crystal material is preferably −10 to −2, more preferably −4 to −2.5. Such a liquid crystal material having a large absolute value of anisotropy of dielectric constant contains a large amount of a highly polar liquid crystal compound(s), and thus easily causes a decrease in VHR and an increase in rDC due to conversion of the azobenzene group into a radical ion by injection of carriers from the pixel electrodes and subsequent transfer of the radical ion to the liquid crystal material. However, as described above, the alignment films 41 and 42 each containing an azobenzene group-containing polymer are disposed out of contact with the pixel electrodes 12, so that a decrease in VHR and an increase in rDC can be effectively suppressed even when the liquid crystal material having anisotropy of dielectric constant is used.

When the liquid crystal material has positive anisotropy of dielectric constant, the liquid crystal material preferably includes at least one of: at least one liquid crystal compound containing a group represented by the following chemical formula (A1), or at least one liquid crystal compound containing a group represented by the following chemical formula (A2). Any of these liquid crystal compounds may be used alone or in combination of two or more thereof. These liquid crystal compounds are highly polar liquid crystal compounds having positive anisotropy of dielectric constant. They have high polarity because one oxygen atom and two fluorine atoms are bonded to one carbon atom, which increases the nucleophilicity of the carbon atom. Thus, a contact between the alignment film containing an azobenzene group-containing polymer and the pixel electrode easily results in transfer of a radical ion generated from the azobenzene group to these liquid crystal compounds, easily causing a decrease in VHR and an increase in rDC. However, when the alignment films 41 and 42 each containing an azobenzene group-containing polymer are disposed out of contact with the pixel electrodes 12 as in the present embodiment, it is possible to effectively suppress a decrease in VHR and an increase in rDC even when the liquid crystal layer 30 contains these highly polar liquid crystal compounds described above. Use of these highly polar liquid crystal compounds also enables low voltage driving of the liquid crystal display device 1. Further, these liquid crystal compounds, which are strongly bonded to each other due to their high polarity, can increase the Tni of the liquid crystal material. Thus, it is possible to control the Tni of the liquid crystal material using these liquid crystal compounds to prevent the Tni from being too low.

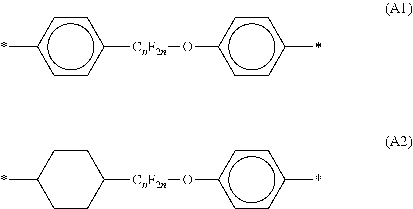

In the above formulae, n represents an integer of 1 to 3; * represents a binding site; and at least one hydrogen atom may be replaced.

When at least one hydrogen atom in the group represented by the chemical formula (A1) is replaced, it is preferably replaced by a halogen atom, more preferably by a fluorine atom. When at least one hydrogen atom in the group represented by the chemical formula (A2) is replaced, it is preferably replaced by a halogen atom, more preferably by a fluorine atom.

When the liquid crystal material has positive anisotropy of dielectric constant, the total amount of the liquid crystal compound containing the group represented by the chemical formula (A1) and the liquid crystal compound containing the group represented by the chemical formula (A2) in the liquid crystal material is preferably 3 to 70 wt %, more preferably 5 to 50 wt %, relative to the total amount of the liquid crystal material. A decrease in VHR and an increase in rDC tend to occur when the liquid crystal material contains a large amount of a polar liquid crystal compound(s) as described above. However, in the liquid crystal display device 1 of the present embodiment, since the first alignment film 41 and the second alignment film 42 each containing an azobenzene group-containing polymer are both disposed out of contact with the pixel electrodes 12, it is possible to effectively suppress a decrease in VHR and an increase in rDC in the liquid crystal display device 1. This embodiment also enables low voltage driving of the liquid crystal display device 1.

In the chemical formulae (A1) and (A2), n is preferably 1. Usually, the azobenzene group absorbs light in the wavelength region from the ultraviolet light wavelength region to the visible light wavelength region. Thus, the azobenzene group absorbs light from the backlight, and undergoes a cleavage reaction. However, since a compound containing a benzene ring, a fluorine group, and an oxygen group forms an association with the azobenzene group by mutual interactions (dipole-dipole interactions) as shown in the following formula 4, cleavage of the azobenzene group by light irradiation is less likely to occur. Thus, a decrease in VHR is further less likely to occur and an increase in rDC is further less likely to occur even after long-term use.

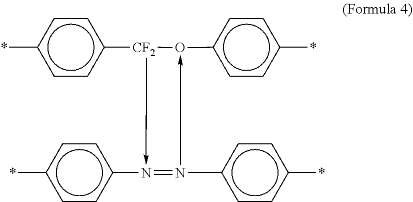

Preferred embodiments of the liquid crystal compound containing the group represented by the chemical formula (A1) may include highly polar liquid crystal compounds having positive anisotropy of dielectric constant represented by the following chemical formulae (A1-1) to (A1-3). Preferred embodiments of the liquid crystal compound containing the group represented by the chemical formula (A2) include highly polar liquid crystal compounds having positive anisotropy of dielectric constant represented by the following chemical formulae (A2-1) to (A2-4). Any of these may be used alone or in combination of two or more thereof.

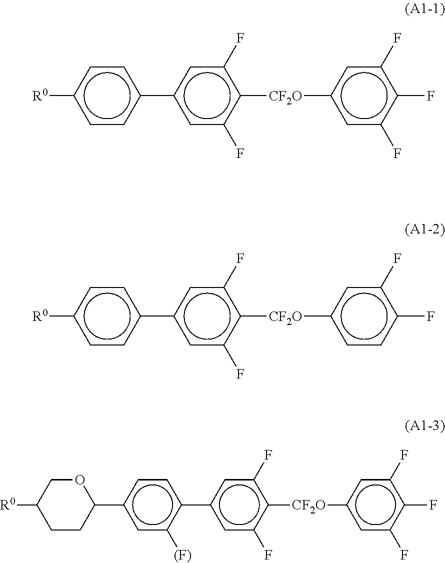

In the above formulae, each R⁰ independently represents a C1-C12 saturated alkyl group.

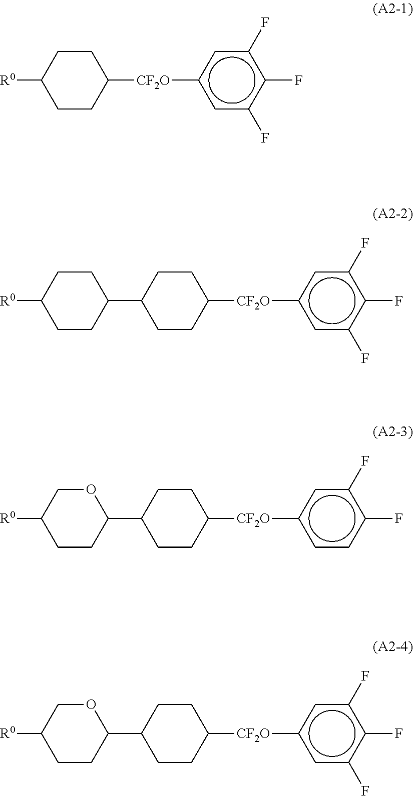

In the above formulae, each R⁰ independently represents a C1-C12 saturated alkyl group.

When the liquid crystal material has positive anisotropy of dielectric constant, the liquid crystal material may contain, in addition to the highly polar liquid crystal compound having positive anisotropy of dielectric constant, a lowly polar or nonpolar liquid crystal compound having positive anisotropy of dielectric constant.

When the liquid crystal material has negative anisotropy of dielectric constant, the liquid crystal material preferably contains at least one liquid crystal compound containing a group represented by the following chemical formula (B1). Any of these liquid crystal compounds may be used alone or in combination of two or more thereof. These liquid crystal compounds are relatively highly polar liquid crystal compounds having negative anisotropy of dielectric constant. They have high polarity because one oxygen atom and two halogen atoms are bonded to one aromatic ring, which increases the nucleophilicity of the aromatic ring. Thus, a contact between the alignment film containing an azobenzene group-containing polymer and the pixel electrode easily results in transfer of a radical ion generated from the azobenzene group to these liquid crystal compounds, easily causing a decrease in VHR and an increase in rDC. However, when the alignment films 41 and 42 each containing an azobenzene group-containing polymer are disposed out of contact with the pixel electrodes 12 as in the present embodiment, it is possible to effectively suppress a decrease in VHR and an increase in rDC even when the liquid crystal layer 30 contains these highly polar liquid crystal compounds described above. Use of these highly polar liquid crystal compounds also enables low voltage driving of the liquid crystal display device 1. Further, these liquid crystal compounds, which are strongly bonded to each other due to their high polarity, can increase the Tni of the liquid crystal material. Thus, it is possible to control the Tni of the liquid crystal material using these liquid crystal compounds to prevent the Tni from being too low.

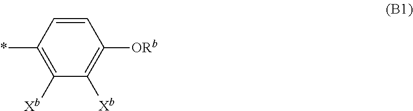

In the above formula, R^{b} represents a C1-C20 saturated alkyl group; each X^{b} independently represents a halogen atom; * represents a binding site; and at least one hydrogen atom may be replaced.

In the chemical formula (B1), R^{b} is preferably a C1-C16 saturated alkyl group, more preferably a C2-C6 saturated alkyl group. R^{b} may be a saturated alkyl group having a linear structure, a saturated alkyl group having a branched structure, or a cyclic saturated alkyl group.

When at least one hydrogen atom in the group represented by the chemical formula (B1) is replaced, it is preferably replaced by a halogen atom, more preferably by a fluorine atom.

When the liquid crystal material has negative anisotropy of dielectric constant, the amount of the liquid crystal compound containing the group represented by the chemical formula (B1) in the liquid crystal material is preferably 3 to 70 wt %, more preferably 5 to 25 wt %, relative to the total amount of the liquid crystal material. A decrease in VHR and an increase in rDC tend to occur when the liquid crystal material contains a large amount of a highly polar liquid crystal compound(s) as described above. However, in the liquid crystal display device 1 of the present embodiment, since the first alignment film 41 and the second alignment film 42 each containing an azobenzene group-containing polymer are both disposed out of contact with the pixel electrodes 12, it is possible to effectively suppress a decrease in VHR and an increase in rDC in the liquid crystal display device 1. This embodiment also enables low voltage driving of the liquid crystal display device 1.

In the chemical formula (B1), at least one X^{b} is preferably a fluorine atom. As described above, usually, the azobenzene group absorbs light in a wavelength region including the visible light wavelength region. Thus, the azobenzene group absorbs light from the backlight, and undergoes a cleavage reaction. However, since a compound containing a benzene ring, a fluorine group, and an oxygen group forms an association with the azobenzene group by mutual interactions (dipole-dipole interactions) as shown in the following formula 5, cleavage of the azobenzene group by light irradiation is less likely to occur. Thus, a decrease in VHR is further less likely to occur and an increase in rDC is further less likely to occur even after long-term use. In addition, since at least one X^{b} in the chemical formula (B1) is a fluorine atom, the liquid crystal compound containing the group represented by the chemical formula (B1) can have higher polarity, enabling lower voltage driving of the liquid crystal display device 1.

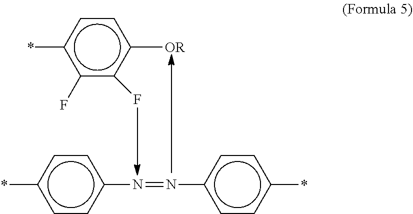

Preferred embodiments of the liquid crystal compound containing the group represented by the chemical formula (B1) include highly polar liquid crystal compounds having negative anisotropy of dielectric constant represented by the following chemical formulae (B21) to (B25). Any of these can be used alone or in combination of two or more thereof.

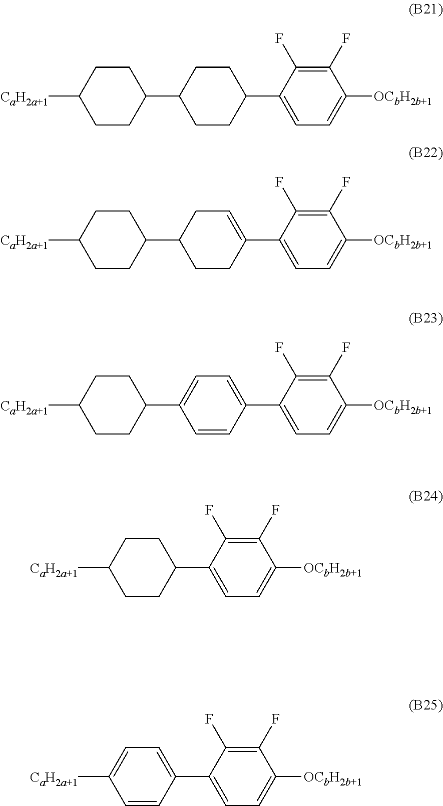

In the above formulae, a and b each independently represent an integer of 1 to 12.

Specific examples of the liquid crystal compound represented by the chemical formula (B23) include a highly polar liquid crystal compound having negative anisotropy of dielectric constant represented by the following chemical formula (B23-1):

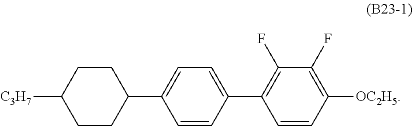

When the liquid crystal material has negative anisotropy of dielectric constant, the liquid crystal material may contain, in addition to the highly polar liquid crystal compound having negative anisotropy of dielectric constant, a lowly polar or nonpolar liquid crystal compound having negative anisotropy of dielectric constant.

The alignment films (the first alignment film 41 and the second alignment film 42) included in the liquid crystal display device 1 have a function to control alignment of liquid crystal molecules in the liquid crystal layer 30. When a voltage applied to the liquid crystal layer 30 is lower than the threshold voltage (including no-voltage application), the alignment of liquid crystal molecules in the liquid crystal layer is controlled mainly by the function of the alignment films. In this state (hereinafter also referred to as an “initial alignment state”), the angle formed by the major axis of the liquid crystal compound relative to the surfaces of the substrates (the first substrate 10 and the second substrate 20) is referred to as a “pre-tilt angle”. The “pre-tilt angle” as used herein indicates the degree of tilt of the liquid crystal compound from the direction parallel to the substrate surface. The angle parallel to the substrate surface is 0°, and the angle normal to the substrate surface is 90°.

The first and second alignment films 41 and 42 are horizontal alignment films that substantially horizontally align the molecules of the liquid crystal compound in the liquid crystal layer 30, and the pre-tilt angle is preferably 0° or more and 5° or less.

The first and second alignment films 41 and 42 each contain an azobenzene group-containing polymer. The azobenzene group is a group in which one or more (preferably two or more) hydrogen atoms are removed from azobenzene, and is introduced into at least one of a main chain or side chain of the azobenzene group-containing polymer. At least one hydrogen atom of the azobenzene group introduced into the azobenzene group-containing polymer may be replaced.

The azobenzene group is a photoalignable functional group that is isomerized by light irradiation. Thus, the first and second alignment films 41 and 42 can be treated for photoalignment. The photoalignment treatment can provide more uniform alignment than rubbing treatment, and thus can suppress a decrease in the contrast ratio of the liquid crystal display device 1. The present embodiment describes a case where the first and second alignment films 41 and 42 each contain an azobenzene group-containing polymer, but it suffices as long as at least the first alignment film 41 contains an azobenzene group-containing polymer.

The azobenzene group-containing polymer in each of the first and second alignment films 41 and 42 preferably has an azobenzene group in the main chain. With this embodiment, the alignment azimuths of the liquid crystal molecules can be controlled at a very small pre-tilt angle (0° or more, 1° or less).

The azobenzene group-containing polymer preferably has at least one of a polyamic acid structure or a polyimide structure. Examples of the polymer having at least one of a polyamic acid structure or a polyimide structure include non-imidized polyamic acids (polymers containing a polyamic acid structure and containing no polyimide structure), polyimides obtained by complete imidization of polyamic acids (polymers containing a polyimide structure and containing no polyamic acid structure), and polyimides obtained by partial imidization of polyamic acids (polymers containing a polyimide structure and a polyamic acid structure).

The polyamic acid structure is preferably a structure represented by the following chemical formula (PA). Any of these can be used alone or in combination of two or more thereof. The polyimide structure is preferably a structure represented by the following chemical formula (PI). Any of these can be used alone or in combination of two or more thereof. The pre-tilt angle is often more than 1° when, for example, the alignment film contains a vinyl-based polymer or polysiloxane which has a flexible main chain. However, when the azobenzene group-containing polymer has at least one of a polyamic acid structure represented by the following chemical formula (PA) or a polyimide structure represented by the following chemical formula (PI), an azobenzene group is introduced into the main chain of at least one of a polyamic acid or a polyimide each having a relatively rigid main chain, so that the alignment azimuth of the liquid crystal molecules can be more easily controlled at a very small pre-tilt angle (0° or more and 1° or less).

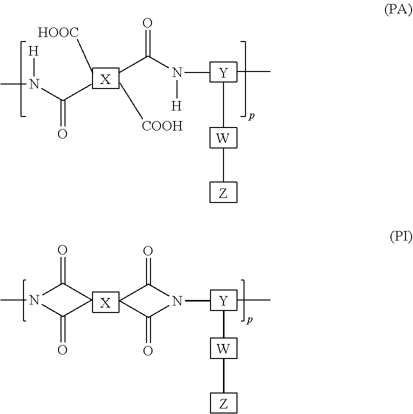

In the above formulae, when X is a group represented by the following chemical formula (X-1), each Y is the same or different and is a group represented by any of the following chemical formulae (Y-3) to (Y-11); when Y is a group represented by the following chemical formula (Y-1) or (Y-2), each X is the same or different and is a group represented by any of the following chemical formulae (X-2) to (X-8); each W is the same or different and is a direct bond or a group represented by any of the following chemical formulae (W-1) to (W-3); each Z is the same or different and is a group represented by any of the following chemical formulae (Z-1) to (Z-8); and p represents an integer of 1 or greater:

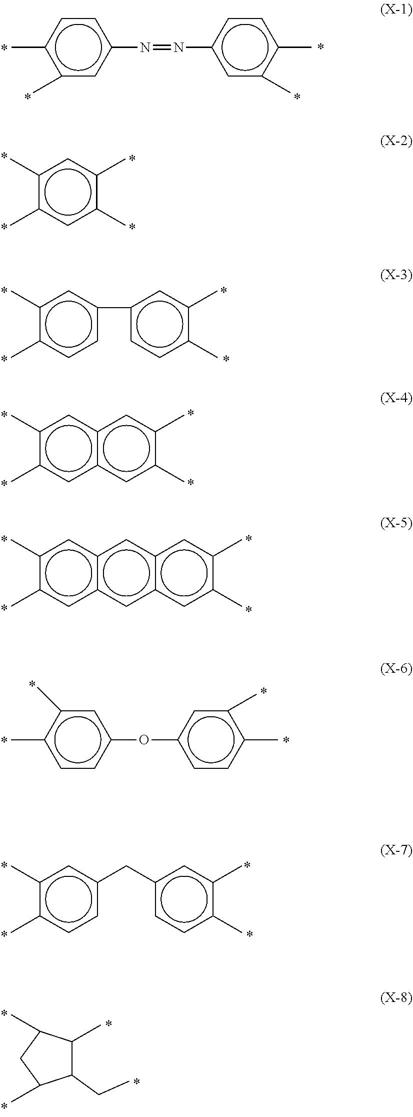

wherein * represents a binding site, and at least one hydrogen atom may be replaced,

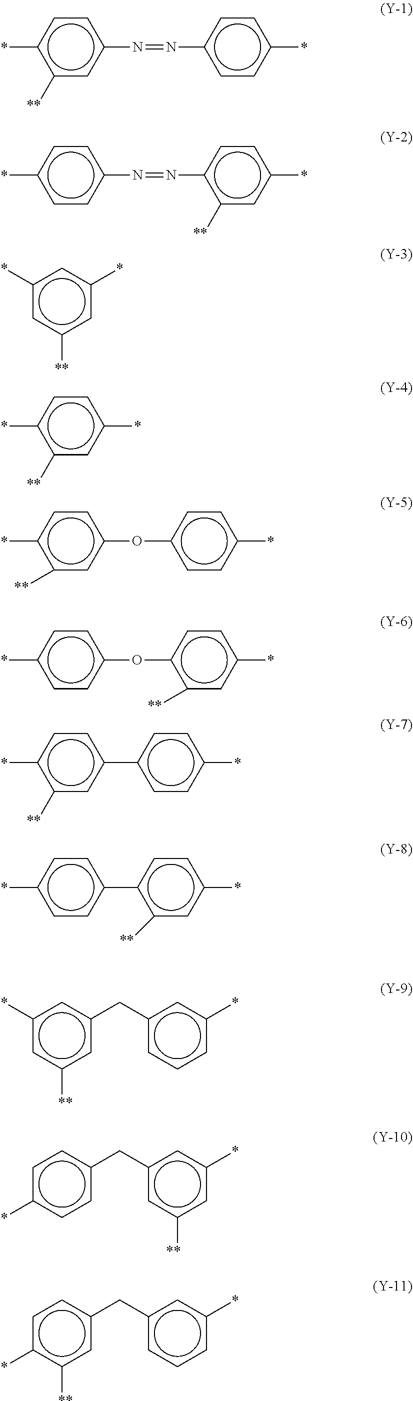

wherein * represents a binding site to a nitrogen atom; ** represents a binding site to W; and at least one hydrogen atom may be replaced,

*—COO—* (W-1)

*—CONH—* (W-2)

*—O—* (W-3)

wherein * represents a binding site,

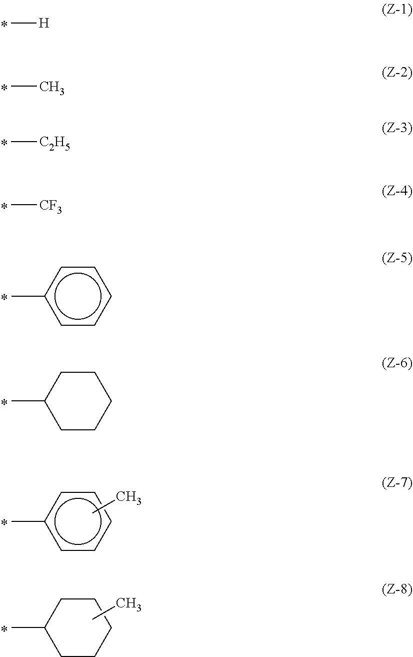

wherein * represents a binding site, and at least one hydrogen atom may be replaced.

At least one hydrogen atom in each of the groups represented by the chemical formulae (X-1) to (X-8) may be replaced by a halogen atom, a methyl group, or an ethyl group. At least one hydrogen atom in each of the groups represented by the chemical formulae (Y-1) to (Y-11) may be replaced by a halogen atom, a methyl group, or an ethyl group. At least one hydrogen atom in each of the groups represented by the chemical formulae (Z-1) to (Z-8) may be replaced by a halogen atom, a methyl group, or an ethyl group.

X in the chemical formulae (PA) and (PI) is preferably a group represented by the chemical formula (X-8). The group represented by the chemical formula (X-8) is flexible and asymmetric so that the polymer main chain has a twisted structure, which slightly reduces the density of molecules in the alignment film. As a result, isomerization of the azobenzene group easily occurs. X in the chemical formulae (PA) and (PI) is preferably at least one group represented by (X-6) or (X-7). The group represented by the chemical formula (X-6) or (X-7) has a twisted structure, which slightly reduces the density of molecules in the alignment film. As a result, isomerization of the azobenzene group easily occurs.

In one molecule of a polymer having the structure represented by the chemical formula (PA), each of X, Y, W, and Z may be of one type or multiple types. In one molecule of a polymer having the structure represented by the chemical formula (PI), each of X, Y, W, and Z may be of one type or multiple types. The azobenzene group-containing polymer may have both structures represented by the chemical formulae (PA) and (PI) in one molecule.

The weight average molecular weight of the azobenzene group-containing polymer is preferably 2,000 to 1,000, 000, more preferably 10,000 to 200,000. The azobenzene group-containing polymer having a weight average molecular weight in the above range facilitates formation of a film having a desired uniform thickness. When the weight average molecular weight of the azobenzene group-containing polymer is too small, a film having a desired thickness cannot be easily formed. A film that is too thick may not only have an uneven thickness but may also have significant irregularities on its surface. Herein, the weight average molecular weight can be measured with gel permeation chromatography (GPC).

The first and second alignment films 41 and 42 each preferably contain at least one azobenzene group-containing polymer represented by the chemical formula (PA) or (PI), and may contain two or more azobenzene group-containing polymers.

The mode of the backlight is not particularly limited. Examples include an edge-light backlight and a direct-light backlight. The type of light sources of the backlight is not particularly limited. Examples include light emitting diodes (LEDs) and cold cathode fluorescent lamps (CCFLs).

The first polarizing plate and the second polarizing plate are both absorption polarizers and are disposed in crossed Nicols with their absorption axes perpendicular to each other. One of the polarization axis of the first polarizing plate or the polarization axis of the second polarizing plate is disposed in a direction parallel to the initial alignment azimuth of the liquid crystal molecules and the other one is disposed in a direction perpendicular to the initial alignment azimuth of the liquid crystal molecules.

### Embodiment 2

In the present embodiment, features specific to the present embodiment are mainly described, and a description duplicated with the above embodiment is omitted. The liquid crystal display device of the present embodiment is an FFS mode liquid crystal display device, and has the same structure as the liquid crystal display device of Embodiment 1 except for a difference in the structure of the first substrate.

FIG. 2 is a schematic cross-sectional view of a liquid crystal display device of Embodiment 2. In the liquid crystal display device 1 of the present embodiment, as shown in FIG. 2, the first substrate 10 includes the insulating substrate 11, the counter electrode 14, a second insulating film 15, the pixel electrodes 12 each including slits, and the first insulating film 13 in this order toward the liquid crystal layer 30. In Embodiment 1, the pixel electrodes 12 and the counter electrode 14 are disposed such that the counter electrode 14 is closer to the liquid crystal layer 30. In the present embodiment, the positions of the pixel electrodes 12 and the counter electrode 14 are switched, and the pixel electrodes 12 each including slits are disposed closer to the liquid crystal layer 30, the planar counter electrode 14 is disposed below the pixel electrodes 12 across the second insulating film 15, and the first insulating film 13 is disposed between the pixel electrodes 12 and the first alignment film 41 such that the pixel electrodes 12 and the first alignment film 41 are out of contact with each other.

As described above, also in the present embodiment, the first alignment film 41 and the second alignment film 42 each containing an azobenzene group-containing polymer are disposed out of contact with the pixel electrodes 12, as in Embodiment 1. With this embodiment, it is possible to prevent the reaction shown in the formula 1 in which a radical anion or a radical cation is generated from the azobenzene group in association with injection of carriers from the pixel electrodes 12. As a result, a reaction that produces a radical or a radical ion in the liquid crystal layer due to the radical anion or the radical cation generated from the azobenzene group can be prevented, which can suppress a decrease in VHR and an increase in residual DC in the liquid crystal display device.

In the present embodiment, the second insulating film 15 disposed between the counter electrode 14 and the pixel electrodes 12 is an inorganic insulating film, but may also be an organic insulating film or a stack of an inorganic insulating film and an organic insulating film. Examples of the inorganic insulating film include inorganic films (relative dielectric constant s=5 to 7) such as silicon nitride (SiNx) films and silicon oxide (SiO₂) films, and multilayer films thereof. Examples of the organic insulating film include organic films having a low relative dielectric constant (relative dielectric constant ε=2 to 5) such as photosensitive acrylic resin films.

In the present embodiment, the pixel electrodes 12 are slit electrodes, and the counter electrode 14 is a planar electrode as shown in FIG. 2, which is opposite to the case shown in FIG. 1. Yet, the counter electrode 14 may be a slit electrode including slits such that the counter electrode 14 entirely overlaps the slits of the pixel electrodes 12.

### Embodiment 3

In the present embodiment, features specific to the present embodiment are mainly described, and a description duplicated with the above embodiment is omitted. The liquid crystal display devices according to Embodiments 1 and 2 are FFS mode liquid crystal display devices, but the present embodiment describes an in-plane switching (IPS) mode liquid crystal display device.

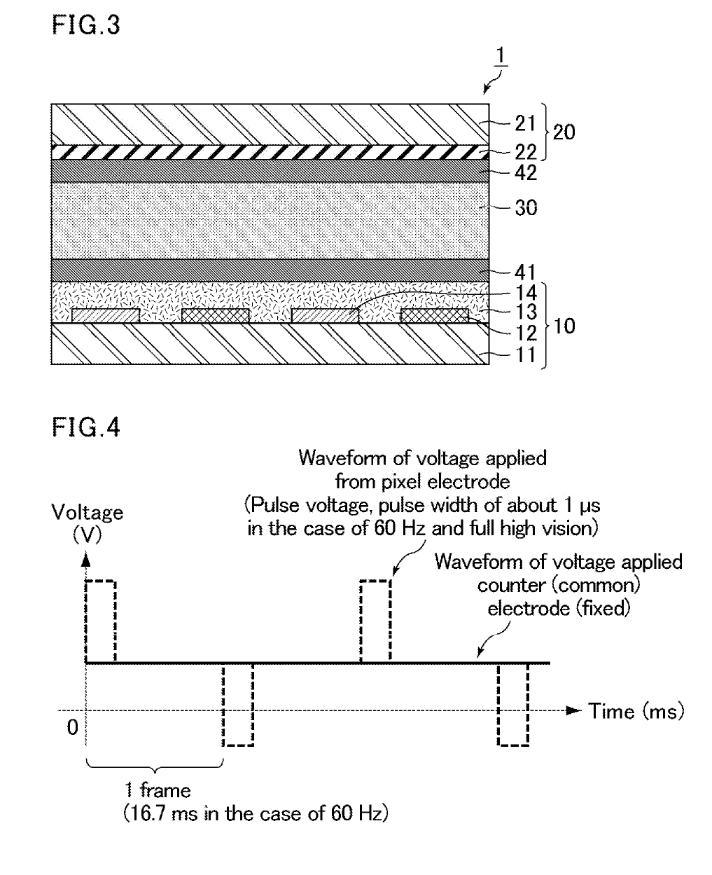

FIG. 3 is a schematic cross-sectional view of a liquid crystal display device of Embodiment 3. In the liquid crystal display device 1 of the present embodiment, as shown in FIG. 3, the first substrate 10 includes the insulating substrate 11, electrodes such as the pixel electrodes 12 and the counter electrode 14, and the insulating film 13 in this order toward the liquid crystal layer 30. In the present embodiment, the insulating film 13 is disposed between the electrodes such as the pixel electrodes 12 and the counter electrode 14, and the first alignment film 41 to prevent contact between the pixel electrodes 12 and the first alignment film 41.

As described above, also in the present embodiment, the first alignment film 41 containing an azobenzene group-containing polymer disposed on the first substrate 10 is disposed out of contact with the pixel electrodes 12 of the first substrate 10. This embodiment can prevent injection of carriers from the pixel electrodes 12 into the first and second alignment films 41 and 42, and can prevent conversion of the azobenzene group into a radical ion by a redox reaction. As a result, it is possible to prevent a reaction that produces a radical or a radical ion in the liquid crystal layer 30 due to radical ions generated from the azobenzene group, thus suppressing a decrease in VHR and an increase in residual DC in the liquid crystal display device 1. Thus, the liquid crystal display device 1 of the present embodiment can achieve a level of problem-free reliability at which no image sticking occurs even after long-term use.

The pixel electrodes 12 and the counter electrode 14 each include comb-teeth electrode portions formed in a comb teeth shape. The comb-teeth electrode portions of the pixel electrodes 12 and the comb-teeth electrode portions of the counter electrode 14 are disposed alternately adjacent to each other. As shown in FIG. 3, in the present embodiment, the pixel electrodes 12 and the counter electrode 14 are disposed on the same layer, but the pixel electrodes 12 and the counter electrode 14 may be disposed on different layers with an insulating film therebetween.

The present invention is described in further detail with reference to examples and comparative examples below, but the present invention is not limited to these examples.

### Examples 1-1 and 1-2 and Comparative Examples 1-1 and 1-2

### Example 1-1

A liquid crystal display device of Example 1-1 is an example of the FFS mode liquid crystal display device 1 according to Embodiment 1. The liquid crystal display device of Example 1-1 was produced by the following method. First, an FFS electrode substrate (first substrate) including pixel electrodes and a counter electrode, and an electrodeless counter substrate (second substrate) were provided. The electrodes on the FFS electrode substrate side were disposed as in Embodiment 1 shown in FIG. 1. Planar pixel electrodes were formed on an insulating substrate, an insulating film was formed on the pixel electrodes, and a counter electrode including slits (openings) were formed on the insulating film. The pixel electrodes and the counter electrode were formed using indium tin oxide (ITO), and the insulating film was formed using SiN.

Next, an alignment film material containing a polyamic acid to be imidized to form an azobenzene group-containing polymer (weight average molecular weight in the range of 5,000 to 50,000) represented by the following chemical formula (PI-1) and a solvent were applied to the FFS electrode substrate and the counter substrate, following by pre-baking at 80° C. for 2 minutes and then by first baking at 120° C. for 40 minutes. Subsequently, after irradiation of 2 J/cm² polarized ultraviolet light, second baking was performed at 230° C. for 40 minutes to imidize the polyamic acid, whereby an alignment film containing an azobenzene group-containing polymer represented by the following chemical formula (PI-1) was formed on each of the FFS electrode substrate and the counter substrate.

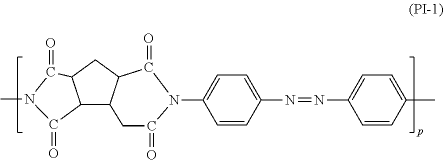

In the above formula, p is an integer of 1 or greater.

Subsequently, a thermosetting sealing material was applied to one of the FFS electrode substrate or the counter substrate, and only a sealing portion was irradiated with ultraviolet light for pre-curing. Subsequently, a positive liquid crystal material (Δε=3.0, Δn=0.12) having a Tni of 70° C. was dropped by a one drop filling (ODF) process, and then the FFS electrode substrate and the counter substrate were bonded to each other, followed by post-curing at 150° C. for 40 minutes. The liquid crystal material contained a liquid crystal compound (positive polar liquid crystal compound) represented by the following chemical formula (A2-1). The amount of the liquid crystal compound represented by the following chemical formula (A2-1) relative to the total amount of the liquid crystal material was in the range of 5 to 30 wt %.

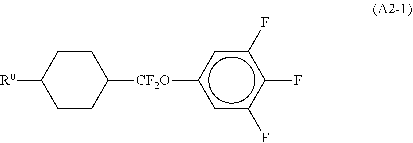

In the above formula, R⁰ represents a C2-05 saturated alkyl group.

Lastly, heating was performed at 130° C. for 40 minutes for re-alignment treatment of the liquid crystal material, followed by cooling to room temperature. Thus, an FFS model liquid crystal display device of Example 1-1 was produced.

### Example 1-2

An FFS mode liquid crystal display device of Example 1-2 was obtained as in the FFS mode liquid crystal display device of Example 1-1, except for using a positive liquid crystal material having a Tni of 75° C. (Δε=3.0, Δn=0.12) instead of the positive liquid crystal material having a Tni of 70° C. The amount of the liquid crystal compound represented by the chemical formula (A2-1) relative to the total amount of the liquid crystal material was in the range of 5 to 30 wt %.

### Comparative Example 1-1

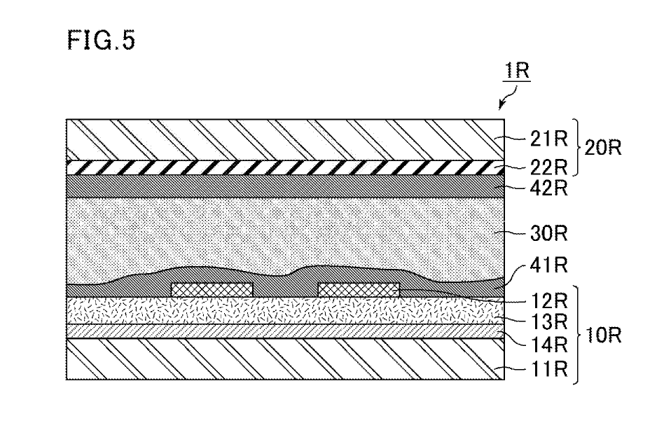

FIG. 5 is a schematic cross-sectional view of a liquid crystal display device of Comparative Example 1-1. A liquid crystal display device of Comparative Example 1-1 was produced as in the liquid crystal display device of Example 1-1, except that the positions of the pixel electrodes and the counter electrode were switched, the pixel electrodes were disposed closer to the liquid crystal layer than the counter electrode was, no openings were provided in the counter electrode, and openings were formed in the pixel electrodes.

As shown in FIG. 5, a liquid crystal display device 1R of Comparative Example 1-1 included: a first substrate (FFS electrode substrate) 10R; a second substrate (counter substrate) 20R disposed opposite to the first substrate 10R; a liquid crystal layer 30R disposed between the first substrate 10R and the second substrate 20R; a first alignment film 41R disposed between the first substrate 10R and the liquid crystal layer 30R; and a second alignment film 42R disposed between the second substrate 20R and the liquid crystal layer 30R. The first the alignment film 41R and the second alignment film 42R each contained the azobenzene group-containing polymer used in Example 1-1. The first substrate 10R in the liquid crystal display device 1R of Comparative Example 1-1 included an insulating substrate 11R, a counter electrode 14R, an insulating film 13R, and pixel electrodes 12R each including slits (openings) in this order toward the liquid crystal layer 30R. In other words, the liquid crystal display device 1R of Comparative Example 1-1 had a structure in which the pixel electrodes 12R were in contact with the alignment film 41R containing an azobenzene group-containing polymer.

### Comparative Example 1-2

An FFS mode liquid crystal display device of Comparative Example 1-2 was obtained as in the FFS mode liquid crystal display device of Comparative Example 1-1, except for using a positive liquid crystal material having a Tni of 75° C. (Δε=3.0, Δn=0.12) instead of the positive liquid crystal material having a Tni of 70° C. The amount of the liquid crystal compound represented by the chemical formula (A2-1) relative to the total amount of the liquid crystal material was in the range of 5 to 30 wt %.

### [High-Temperature Electrification Test]

In order to evaluate image sticking in each FFS mode liquid crystal display device of Examples 1-1 and 1-2 and Comparative Examples 1-1 and 1-2, the liquid crystal display device was left in a constant-temperature bath at 70° C. for 1000 hours while a voltage of 10 V was applied (60 Hz) to measure the VHR and the rDC before and after aging. The VHR was measured at 1 V and 70° C. using a VHR measurement system (Model 6254) available from Toyo Corporation. The rDC was measured by a flicker-minimizing method after application of a DC voltage of 2 V for two hours. Table 1 below shows the results.

TABLE 1

| | Before aging | | After aging for 1000 hours | |
|---|---|---|---|---|
| | VHR (%) | rDC (mV) | VHR (%) | rDC (mV) |
| Example 1-1 | 99.5 | −10 | 99.4 | −10 |
| Comparative | 99.5 | −10 | 96.5 | 70 |
| Example 1-1 | | | | |
| Example 1-2 | 99.5 | −20 | 99.4 | −10 |
| Comparative | 99.5 | −10 | 98.4 | 20 |
| Example 1-2 | | | | |

According to Table 1, in Examples 1-1 and 1-2 in which the alignment films containing an azobenzene group-containing polymer were out of contact with the pixel electrodes, a decrease in VHR and an increase in rDC were hardly observed after aging for 1000 hours. Use of a liquid crystal material having a Tni of 72° C. or lower tends to result in a decrease in VHR and an increase in rDC. However, owing to the structure in which the alignment films containing an azobenzene group-containing polymer were disposed out of contact with the pixel electrodes, the liquid crystal display device of Example 1-1 including a liquid crystal material having a Tni of 72° C. or lower was capable of suppressing a decrease in VHR and an increase in rDC to a similar degree as in the liquid crystal display device of Example 1-2. In other words, the present invention can particularly effectively suppress a decrease in VHR and an increase in rDC when a liquid crystal material having a Tni of 72° C. or lower is used.

In contrast, in Comparative Examples 1-1 and 1-2 in which the alignment films containing an azobenzene group-containing polymer were in contact with the pixel electrodes, the VHR decreased significantly and the rDC increased after aging for 1000 hours. It is highly possible that the azobenzene group was converted into a radical ion by injection of carriers from the pixel electrodes and the radical ion was transferred to the liquid crystal material. Comparative Example 1-2 in which the Tni of the liquid crystal material was 75° C. showed a similar tendency as in Comparative Example 1-1 in which the Tni was 70° C. Yet, owing to a higher Tni, the degree of the decrease in VHR and the degree of the increase in rDC in Comparative Example 1-2 were smaller than those in Comparative Example 1-1.

### Examples 2-1 to 2-3 and Comparative Examples 2-1 to 2-3

### Example 2-1

An FFS mode liquid crystal display device of Example 2-1 was produced as in Example 1-1, except for using a positive liquid crystal material having a Tni of 60° C. (Δε=3.0, Δn=0.12) instead of the positive liquid crystal material having a Tni of 70° C. The liquid crystal material contained a liquid crystal compound (positive polar liquid crystal compound) represented by the following chemical formula (A2-2). The amount of the liquid crystal compound represented by the following chemical formula (A2-2) relative to the total amount of the liquid crystal material was in the range of 5 to 30 wt %.

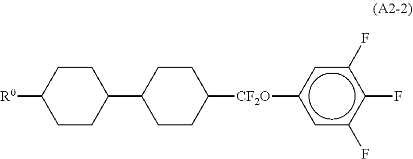

In the above formula, R⁰ represents a C4 saturated linear alkyl group.

### Example 2-2

An FFS mode liquid crystal display device of Example 2-2 was produced as in Example 1-1, except for using a positive liquid crystal material having a Tni of 60° C. (Δε=6.0, Δn=0.12) instead of the positive liquid crystal material having a Tni of 70° C. The amount of the liquid crystal compound represented by the chemical formula (A2-2) relative to the total amount of the liquid crystal material was in the range of 5 to 30 wt %.

### Example 2-3

An FFS mode liquid crystal display device of Example 2-3 was produced as in Example 1-1, except for using a positive liquid crystal material having a Tni of 60° C. (Δε=9.0, Δn=0.12) instead of the positive liquid crystal material having a Tni of 70° C. The amount of the liquid crystal compound represented by the chemical formula (A2-2) relative to the total amount of the liquid crystal material was in the range of 5 to 30 wt %.

### Comparative Example 2-1

An FFS mode liquid crystal display device of Comparative Example 2-1 was produced as in Comparative Example 1-1, except for using a positive liquid crystal material having a Tni of 60° C. (Δε=3.0, Δn=0.12) instead of the positive liquid crystal material having a Tni of 70° C. The amount of the liquid crystal compound represented by the chemical formula (A2-2) relative to the total amount of the liquid crystal material was in the range of 5 to 30 wt %.

### Comparative Example 2-2

An FFS mode liquid crystal display device of Comparative Example 2-2 was produced as in Comparative Example 1-1, except for using a positive liquid crystal material having a Tni of 60° C. (A=6.0, Δn=0.12) instead of the positive liquid crystal material having a Tni of 70° C. The amount of the liquid crystal compound represented by the chemical formula (A2-2) relative to the total amount of the liquid crystal material was in the range of 5 to 30 wt %.

### Comparative Example 2-3

An FFS mode liquid crystal display device of Comparative Example 2-3 was produced as in Comparative Example 1-1, except for using a positive liquid crystal material having a Tni of 60° C. (A=9.0, Δn=0.12) instead of the positive liquid crystal material having a Tni of 70° C. The amount of the liquid crystal compound represented by the chemical formula (A2-2) relative to the total amount of the liquid crystal material was in the range of 5 to 30 wt %.

### [High-Temperature Power-on Test]

As in Example 1-1, the high-temperature power-on test was performed for Examples 2-1 to 2-3 and Comparative Examples 2-1 to 2-3. Table 2 below shows the results.

TABLE 2

| | Before aging | | After aging for 1000 hours | |
|---|---|---|---|---|
| | VHR (%) | rDC (mV) | VHR (%) | rDC (mV) |
| Example 2-1 | 99.4 | 0 | 99.4 | 0 |
| Δε = 3.0 | | | | |
| Example 2-2 | 99.3 | 0 | 99.1 | 0 |
| Δε = 6.0 | | | | |
| Example 2-3 | 99.3 | 0 | 99.0 | 10 |
| Δε = 9.0 | | | | |
| Comparative | 99.4 | 0 | 95.8 | 80 |
| Example 2-1 | | | | |
| Δε = 3.0 | | | | |
| Comparative | 99.4 | 10 | 95.0 | 140 |
| Example 2-2 | | | | |
| Δε = 6.0 | | | | |
| Comparative | 99.3 | 10 | 93.2 | 230 |
| Example 2-3 | | | | |
| Δε = 9.0 | | | | |

Examples 2-1 to 2-3 in Table 2 show that a decrease in VHR and an increase in rDC after aging for 1000 hours were suppressed even when a positive liquid crystal material having a Tni of 60° C. and having a Δε in the range of 3.0 to 9.0 was used, owing to the structure in which the alignment films containing an azobenzene group-containing polymer were disposed out of contact with the pixel electrodes.

In contrast, in Comparative Examples 2-1 to 2-3 in which the alignment films containing an azobenzene group-containing polymer were in contact with the pixel electrodes, the VHR decreased significantly and the rDC increased after aging for 1000 hours. In particular, the decrease in VHR and the increase in rDC became more noticeable with the increase in Δε of the liquid crystal material. These results further clearly show that the azobenzene group in the azobenzene group-containing polymer in the alignment films was converted into a radical ion by injection of carriers from the pixel electrodes and the radical ion was transferred to the liquid crystal material (particularly, the liquid crystal compound containing a polar group).

### Example 3 and Comparative Examples 3-1 to 3-3

### Example 3

An FFS mode liquid crystal display device of Example 3 was produced as in Example 1-1, except for using a negative liquid crystal material containing a liquid crystal compound represented by the following chemical formula (B21-1) (a negative and highly polar liquid crystal compound) and having a Tni of 71° C. (Δε=−3.5, Δn=0.10). The amount of the liquid crystal compound represented by the following chemical formula (B21-1) relative to the total amount of the liquid crystal material was in the range of 1 to 10 wt %.

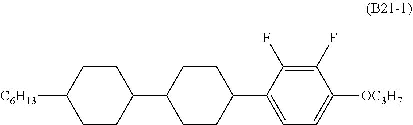

### Comparative Example 3-1

An FFS mode liquid crystal display device of Comparative Example 3-1 was produced as in Comparative Example 1-1, except for using a negative liquid crystal material containing the liquid crystal compound represented by the chemical formula (B21-1) and having a Tni of 71° C. (Δε=−3.5, Δn=1.0). The amount of the liquid crystal compound represented by the chemical formula (B21-1) relative to the total amount of the liquid crystal material was in the range of 1 to 10 wt %.

### Comparative Example 3-2

An FFS mode liquid crystal display device of Comparative Example 3-2 was produced as in Example 3, except for forming alignment films using a polymer having a cyclobutane ring represented by the following chemical formula (PI-R) (weight average molecular weight in the range of 5,000 to 50,000) instead of the azobenzene group-containing polymer represented by the chemical formula (PI-1). The alignment films containing a cyclobutane ring can be treated for photoalignment.

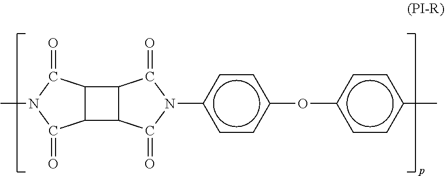

In the above formula, p is an integer of 1 or greater.

### Comparative Example 3-3

An FFS mode liquid crystal display device of Comparative Example 3-3 was produced as in Comparative Example 3-1, except for forming alignment films using the polymer having a cyclobutane ring represented by the chemical formula (PI-R) (weight average molecular weight in the range of 5,000 to 50,000) instead of the azobenzene group-containing polymer represented by the chemical formula (PI-1).

### [High-Temperature Power-on Test]

As in Example 1-1, the high-temperature power-on test was performed for Example 3 and Comparative Examples 3-1 to 3-3. Table 3 below shows the results.

TABLE 3

| | Before aging | | After aging for 1000 hours | |
|---|---|---|---|---|
| | VHR (%) | rDC (mV) | VHR (%) | rDC (mV) |
| Example 3 | 99.4 | 0 | 99.0 | 20 |
| Comparative | 99.4 | 0 | 96.9 | 130 |
| Example 3-1 | | | | |
| Comparative | 99.5 | 0 | 97.7 | 60 |
| Example 3-2 | | | | |
| Comparative | 99.4 | 0 | 97.3 | 70 |
| Example 3-3 | | | | |

Example 3 in Table 3 shows that a decrease in VHR and an increase in rDC after aging for 1000 hours were suppressed also when a negative liquid crystal material was used, owing to the structure in which the alignment films containing an azobenzene group-containing polymer were disposed out of contact with the pixel electrodes.

In contrast, in Comparative Example 3-1 in which the alignment films containing an azobenzene group-containing polymer were in contact with the pixel electrodes, the VHR decreased significantly and the rDC increased significantly after aging for 1000 hours. Also when a negative liquid crystal material was used, it is highly possible that the azobenzene group was converted into a radical ion by injection of carriers from the pixel electrodes and the radical ion was transferred to the liquid crystal material.

In contrast, in Comparative Examples 3-2 and 3-3 in which the photoalignment film material contained a material having a cyclobutane ring, the VHR was decreased to the 97% range and the rDC was somewhat high (60 mV) after aging for 1000 hours, regardless of whether or not the pixel electrodes were in contact with the alignment films. A decrease in VHR and an increase in rDC occurred assumedly because the cyclobutane ring decomposed by polarized ultraviolet light irradiation and the decomposition product dissolved into the negative liquid crystal material.

### Example 4 and Comparative Examples 4-1 to 4-2

### Example 4

An FFS mode liquid crystal display device of Example 4 was obtained as in the FFS mode liquid crystal display device of Example 1-1, except for using a negative liquid crystal material having a Tni of 65° C. (Δε=−3.3, Δn=0.09). The negative liquid crystal material contained a negative and highly polar liquid crystal compound represented by the chemical formula (B21-1). The amount of the liquid crystal compound represented by the chemical formula (B21-1) relative to the total amount of the liquid crystal material was in the range of 1 to 10 wt %.

### Comparative Example 4-1

An FFS mode liquid crystal display device of Comparative Example 4-1 was obtained as in the FFS mode liquid crystal display device of Comparative Example 1-1, except for using the liquid crystal material used in Example 4.

### Comparative Example 4-2

An FFS mode liquid crystal display device of Comparative Example 4-2 was obtained as in the FFS mode liquid crystal display device of Comparative Example 1-1, except for using a liquid crystal material containing only a liquid crystal compound represented by the following chemical formula (D2-1) (non-polar liquid crystal compound) (Δε=−3.3, Δn=0.09, Tni=65° C.).

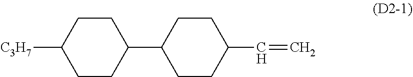

### [High-Temperature Power-on Test]

As in Example 1-1, the high-temperature power-on test was performed also for Example 4 and Comparative Examples 4-1 and 4-2. Table 4 below shows the results.

TABLE 4

| | Before aging | | After aging for 1000 hours | |
|---|---|---|---|---|
| | VHR (%) | rDC (mV) | VHR (%) | rDC (mV) |
| Example 4 | 99.4 | 0 | 99.1 | 20 |
| Comparative | 99.4 | 0 | 96.6 | 150 |
| Example 4-1 | | | | |
| Comparative | 98.0 | — | 97.6 | — |
| Example 4-2 | | | | |

According to Table 4, Example 4 in which the alignment films containing an azobenzene group-containing polymer were out of contact with the pixel electrodes showed no significant decrease in VHR and practically no increase in rDC after aging of 1000 hours even when a negative liquid crystal material was used, as in Example 3.

In contrast, in Comparative Example 4-1 in which the alignment films containing an azobenzene group-containing polymer were in contact with the pixel electrodes, the VHR decreased significantly and the rDC increased significantly after aging for 1000 hours. Also when a negative liquid crystal material was used, it is highly possible that the azobenzene group was converted into a radical ion by injection of carriers from the pixel electrodes and the radical ion was transferred to the liquid crystal material (the same tendency as in Example 3).

Next, in Comparative Example 4-2 in which the liquid crystal material containing only the liquid crystal compound represented by the chemical formula (D2-1) was used, the difference in VHR before aging (initial) and after aging for 1000 hours was small. Thus, assumedly, a radical ion did not transfer to the liquid crystal layer even when carriers were injected into the azobenzene group. Since the liquid crystal material did not contain a polar component in Comparative Example 4-2, the liquid crystal layer did not respond to an electric field, and the rDC was thus unmeasurable.

### Examples 5 and 6

### Example 5

A liquid crystal display device of Example 5 is an example of the FFS mode liquid crystal display device 1 according to Embodiment 2, and was produced as in the liquid crystal display device of Example 1-1, except that the positions and the structures of the pixel electrodes and the counter electrode were different. In Example 1-1, the pixel electrodes and the counter electrode were disposed such that the counter electrode was closer to the liquid crystal layer. However, in Example 5, the positions of the pixel electrodes and the counter electrode were switched, the pixel electrodes were disposed closer to the liquid crystal layer, and the first insulating film 13 was disposed between the pixel electrodes and the first alignment film such that the pixel electrodes were out of contact with the first alignment film.

More specifically, an FFS electrode substrate (first substrate) including pixel electrodes and a counter electrode and an electrodeless counter substrate (second substrate) were provided. The electrodes on the FFS electrode substrate were disposed as in Embodiment 2 shown in FIG. 2, and the FFS electrode substrate sequentially included an insulating substrate, a planar counter electrode, a first insulating film, pixel electrodes each including slits (openings), and a second insulating film. The pixel electrodes and the counter electrode were formed using ITO, and the first and second insulating films were formed using SiN.

### Example 6

A liquid crystal display device of Example 6 is an example of the IPS mode liquid crystal display device 1 according to Embodiment 3, and was produced as in the liquid crystal display device of Example 1-1, except that the positions and the structures of the pixel electrodes and the counter electrode were different. First, a first substrate including the pixel electrodes and the counter electrode and an electrodeless second substrate were provided. The electrodes on the first substrate were disposed as in Embodiment 3 shown in FIG. 3. The first substrate included an insulating substrate, a comb-teeth counter electrode and comb-teeth pixel electrodes on the insulating substrate, and an insulating film on the pixel electrodes and the counter electrode. The pixel electrodes and the counter electrode were formed using ITO on the same layer, and were disposed such that the comb teeth of the pixel electrodes would alternate with the comb teeth of the counter electrode. The insulating film was formed using SiN.

### [High-Temperature Power-on Test]

As in Example 1-1, the high-temperature power-on test was performed for Examples 5 and 6. Table 5 below shows the results.

TABLE 5

| | Before aging | | After aging for 1000 hours | |
|---|---|---|---|---|
| | VHR (%) | rDC (mV) | VHR (%) | rDC (mV) |
| Example 5 | 99.5 | −10 | 99.5 | −10 |
| Example 6 | 99.3 | −20 | 99.3 | −10 |

Table 5 shows that, also in the FFS mode liquid crystal display device including a layer structure different from that in Embodiment 1 and the IPS mode liquid crystal display device, a decrease in VHR and an increase in rDC after aging for 1000 hours were suppressed, as long as the alignment films containing an azobenzene group-containing polymer were disposed out of contact with the pixel electrodes.

What is claimed is:

1. A liquid crystal display device comprising:
a first substrate including a pixel electrode and a counter electrode;
a second substrate disposed opposite to the first substrate;
a liquid crystal layer containing a liquid crystal material between the first substrate and the second substrate; and
an alignment film containing an azobenzene group-containing polymer containing an azobenzene group between the first substrate and the liquid crystal layer,
wherein the alignment film is disposed out of contact with the pixel electrodes.

2. The liquid crystal display device according to claim 1,
wherein the liquid crystal material has a nematic phase-isotropic phase transition point of 72° C. or lower.

3. The liquid crystal display device according to claim 1,
wherein the liquid crystal material has positive anisotropy of dielectric constant.

4. The liquid crystal display device according to claim 1,
wherein the liquid crystal material comprises at least one of: at least one liquid crystal compound containing a group represented by the following chemical formula (A1), or at least one liquid crystal compound containing a group represented by the following chemical formula (A2), 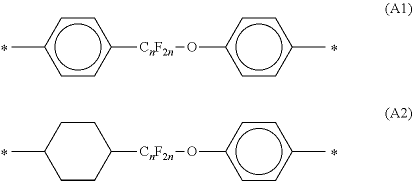
wherein n represents an integer of 1 to 3; * represents a binding site; and at least one hydrogen atom may be replaced.

5. The liquid crystal display device according to claim 4,
wherein in the chemical formulae (A1) and (A2), n is 1.

6. The liquid crystal display device according to claim 1,
wherein the liquid crystal material has negative anisotropy of dielectric constant.

7. The liquid crystal display device according to claim 1,
wherein the liquid crystal material contains at least one liquid crystal compound containing a group represented by the following chemical formula (B1): 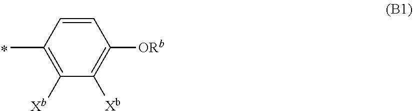
wherein R^{b} represents a C1-C20 saturated alkyl group; each X^{b} independently represents a halogen atom; * represents a binding site; and at least one hydrogen atom may be replaced.

8. The liquid crystal display device according to claim 7,
wherein at least one X^{b} in the chemical formula (B1) is a fluorine atom.

9. The liquid crystal display device according to claim 1,
wherein the azobenzene group-containing polymer comprises an azobenzene group in the main chain.

10. The liquid crystal display device according to claim 1,
wherein the azobenzene group-containing polymer comprises at least one of a polyamic acid structure or a polyimide structure.

11. The liquid crystal display device according to claim 10,
wherein the polyamic acid structure is at least one structure represented by the following chemical formula (PA), and
the polyimide structure is at least one structure represented by the following chemical formula (PI): 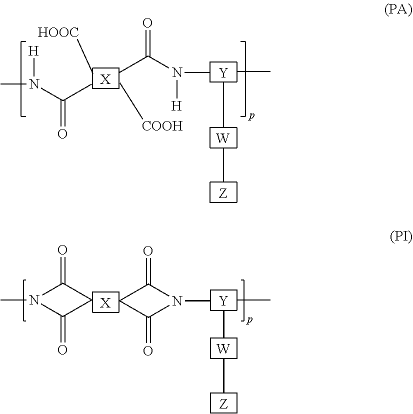
wherein when X is a group represented by the following chemical formula (X-1), each Y is the same or different and is a group represented by any of the following chemical formulae (Y-3) to (Y-11); when Y is a group represented by the following chemical formula (Y-1) or (Y-2), each X is the same or different and is a group represented by any of the following chemical formulae (X-2) to (X-8); each W is the same or different and is a direct bond or a group represented by any of the following chemical formulae (W-1) to (W-3); each Z is the same or different and is a group represented by any of the following chemical formulae (Z-1) to (Z-8); and p represents an integer of 1 or greater, 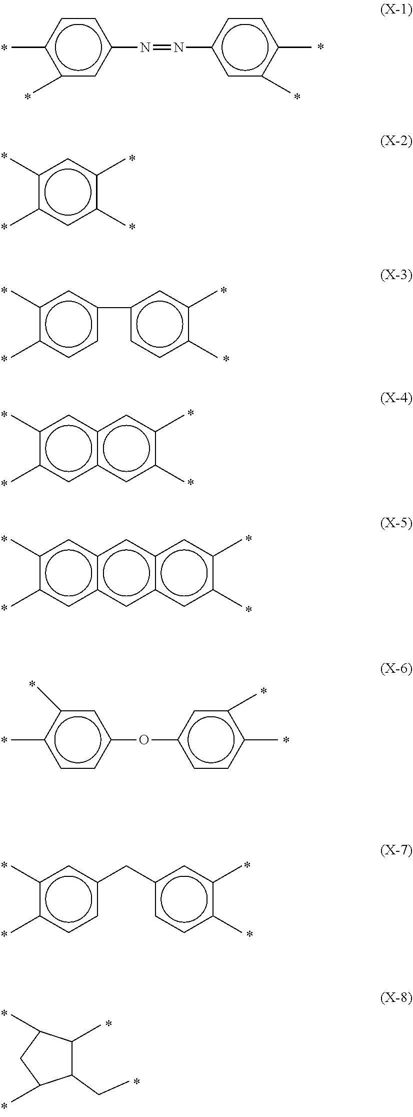
wherein * represents a binding site, and at least one hydrogen atom may be replaced, 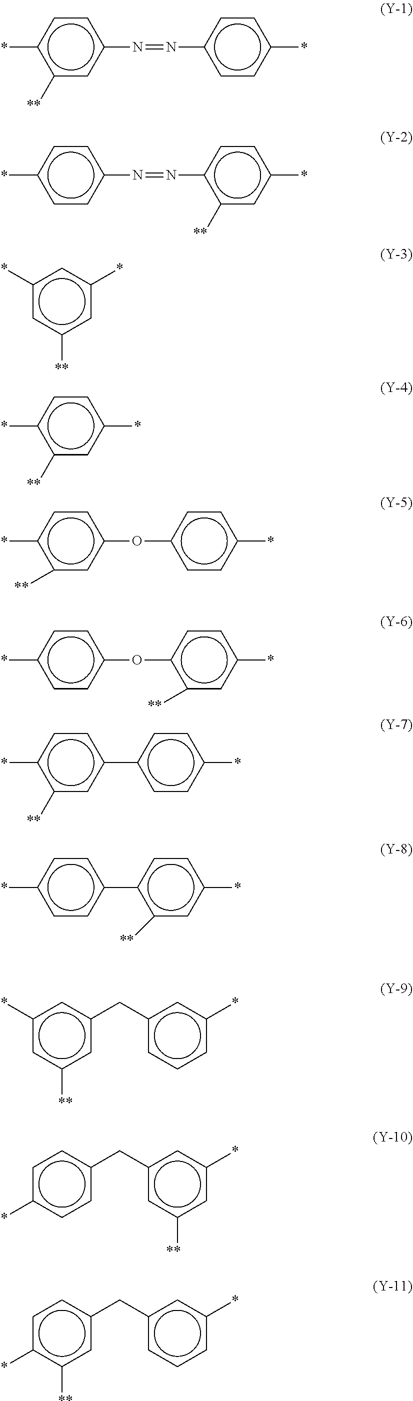
wherein * represents a binding site to a nitrogen atom; ** represents a binding site to W; and at least one hydrogen atom may be replaced,
*—COO—* (W-1)
*—CONH—* (W-2)
*—O—* (W-3)
wherein * represents a binding site, 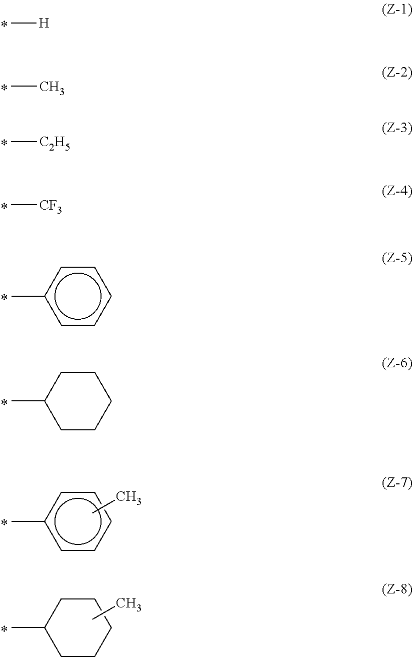
wherein * represents a binding site, and at least one hydrogen atom may be replaced.

12. The liquid crystal display device according to claim 1,
wherein the first substrate further comprises an insulating film, and
the insulating film covers the pixel electrodes and contains no azobenzene group-containing polymer containing an azobenzene group.

13. The liquid crystal display device according to claim 12,
wherein the liquid crystal display device is a fringe field switching mode liquid crystal display device, and
the first substrate comprises the counter electrode, the insulating film, and the pixel electrodes in this order from the liquid crystal layer side.

14. The liquid crystal display device according to claim 12,
wherein the liquid crystal display device is a fringe field switching mode liquid crystal display device,
the insulating film is a first insulating film, and
the first substrate further comprises a second insulating film and comprises the first insulating film, the pixel electrodes, the second insulating film, and the counter electrode in this order from the liquid crystal layer side.

15. The liquid crystal display device according to claim 12,
wherein the liquid crystal display device is an in-plane switching mode liquid crystal display device, and
the insulating film is disposed closer to the liquid crystal layer than the pixel electrodes and the counter electrode are.
